(19) United States
(12) Patent Application Publication
(10) Pub. No.: US 2002/0038677 A1
(43) Pub. Date: Apr. 4, 2002

(54) Disposable funnel

(75) Inventor: Stephanie S. Wiethoff, Albuquerque, NM (US)

Correspondence Address: Simpson, Simpson & Snyder, PLLC, 5555 Main Street, Williamsville, NY, 14221-5406, US

(73) Assignee: Moore North America, Inc., Grand Island, NY (US)

(21) Appl. No.: 09/928,819

(22) Filed: Aug. 13, 2001

Related U.S. Application Data
(63) Continuation-in-part of application No. 09/558,494, filed on Apr. 26, 2000, now abandoned.

(51) Int. Cl. B65B 39/00; B67C 11/04

(52) U.S. Cl. 141/337

(57) ABSTRACT

The present invention broadly comprises a disposable funnel. The disposable funnel is comprised of a planar annular-segment substrate having a top surface and a bottom surface. A first radial edge and a second radial edge bound the substrate. The substrate has a strip of repositionable adhesive disposed on the bottom surface proximate the first radial edge. The substrate is operatively arranged to be formed into a conical-shaped funnel, where the repositionable adhesive disposed on the bottom surface proximate the first radial edge is detachably secured to the top surface proximate the second radial edge. The invention also includes a pad of disposable funnels.

### RELATED APPLICATION

This continuation-in-part patent application claims the benefit of U.S. patent application Ser. No. 09/558,494, filed Apr. 26, 2000.

### FIELD OF THE INVENTION

This invention relates generally to funnels, and, more specifically, to a convenient and expedient means of creating one or more disposable funnels.

### BACKGROUND OF THE INVENTION

A funnel is a conically shaped article of manufacture having a large diameter aperture at a first end, and a smaller diameter aperture at a second end. As is well known, the unique shape and structure of a funnel makes it especially suitable for materials handling. Specifically, a relatively large volume of material may be poured into the larger diameter opening of the funnel and then expelled from the smaller diameter opening of the funnel into a container having a small opening.

The widespread use of funnels is readily apparent from a survey of the industries in which funnels are marketed. Aside from the diverse utility of funnels in the household, the automotive, chemical, and medical industries make up a significant percentage of the consumer class. This list is not exhaustive. Funnels are also used in the aeronautical, agricultural, food, and recreation industries, among others.

In the household, funnels are used to transport, from one container to another, items such as cleaning fluids, detergents, gasoline, and food. In the automotive industry, funnels are used to handle material such as anti-freeze, gasoline, motor oil, and windshield washer fluid. In the agricultural industry, funnels are used to handle insecticides and grains. The applications for funnels are many.

Funnels are made out of a variety of materials, such as aluminum, tin, stainless steel, and polyethylene. In addition, convenience has played a role in the development of funnel products, and the use of such in industry. For example, funnels are sold in different colors and sizes. Designers have also attempted to address the safety concerns associated with the use of funnels in a number of industries.

In the chemical industry, California Pacific Lab & Consulting markets an “eco funnel” for disposing of chemicals or other hazardous waste into waste bottles. Certainly, the disposal of hazardous waste is a concern not only in chemical laboratories, but also in hospitals, manufacturing facilities, and the like. The “eco funnel” is attractive because it comprises a conventional durable plastic funnel with a cap, thus enabling chemists, laboratory technicians, or manufacturing specialists to prevent excessive release of solvent fumes into the air, thereby preventing consequent environmental contamination and technician inhalation.

Durable funnels must be cleaned and stored, often in multiple quantities, not to mention individually purchased. Disposable funnels resolve these issues, while also simplifying the manufacturing process of funnels, and therefore potentially reducing the cost of such to consumers.

An early invention related to paper liners used in cake decorating tubes is disclosed in U.S. Pat. No. 1,543,174, issued over seventy years ago to Joseph B. Mattson. Mr. Mattson was concerned with the problem of interchanging different colored pastes in conventional cake decorating tubes. Prior to the patented invention, cake decorators used cloth bags with removable nozzles to apply the frosting. Thus, it was necessary to wash the bag each time a different color or flavor of frosting was used. Mr. Mattson solved the problem by inventing a disposable paper liner that could be assembled into the shape of a funnel and placed inside of a cake decorating tube. Mr. Mattson's invention comprises a flat paper liner having a gummed adhesive along one edge. To assemble the funnel, a cake decorator would moisten the gummed adhesive on the liner, and roll the liner into the shape of a funnel.

Although the Mattson invention solved the problem at hand, and may have been suitable in its day for applications such as cake decorating, where presumably only a handful of funnels would be on hand (in the kitchen drawer) at any given time, Mattson leaves unanswered the problem of keeping all of the individual funnels in a common package. For example, if one were to drop a plurality of Mattson's liners off a table and onto the floor, it would be inconvenient to re-stack the liners into a neat package again, and may even be unsanitary to use for purposes of cake decorating. The adhesive of Mattson's invention has but a single purpose, i.e., to form the liner into a funnel shape. Since Mattson's invention was created before the invention of repositionable adhesives, it was of course inevitable that his adhesive serve but a single purpose. Mattson does not disclose, teach, or even remotely suggest how one would deal with the problem of keeping a large number of individual funnels together in a common package, such as would be necessary in other, larger industrial and commercial applications.

What is needed, then, is a pad comprising a plurality of ready-to-assemble funnels, where each funnel is detachably secured to its adjacent neighbor(s). Ideally, the pad of funnels would be inexpensive, and each funnel could be assembled quickly, and would be disposable.

### SUMMARY OF THE INVENTION

The present invention broadly comprises a disposable funnel. The disposable funnel is comprised of a planar annular-segment substrate having a top surface and a bottom surface. A first radial edge and a second radial edge bound the substrate. The substrate has a strip of repositionable adhesive disposed on the bottom surface proximate the first radial edge and a corresponding strip of release coating, such as silicone, disposed on the top surface proximate the first radial edge and at least as large as said adhesive strip. The substrate is operatively arranged to be formed into a conical-shaped funnel, where the repositionable adhesive disposed on the bottom surface of the substrate proximate the first radial edge is detachably secured to the top surface proximate the second radial edge. The invention also includes a pad of disposable funnels.

It is the object of this invention to provide disposable funnels that eliminate the need for cleaning.

It is a further object to provide a plurality of funnels in a package, each secured to its adjacent neighbor, in the form of a pad, to facilitate convenient storage and dispensing of the plurality of funnels. The adhesive strip on the bottom surface of each funnel is in contact with the release coating strip on the top surface of each funnel to form the pad.

These and other objects, advantages and features of the present invention will become readily apparent to those having ordinary skill in the art from a reading of the following detailed description of the invention in view of the drawings and appended claims.

### BRIEF DESCRIPTION OF THE DRAWINGS

FIG. 1 is a perspective view of a first embodiment of the funnel of the invention in use atop a bottle;

FIG. 2 is a bottom plan view of a first embodiment of the invention; this view shows an unformed disposable funnel having respositionable adhesive disposed on the bottom surface of the substrate proximate the first radial edge and a release coating strip disposed on the top surface of the substrate proximate the first radial edge;

FIG. 3 is a bottom plan view of a second embodiment of the invention; this view shows an unformed disposable funnel having repositionable adhesive disposed on the bottom surface of the substrate proximate the first radial edge and a second adjacent inner edge and a release coating strip disposed on the top surface of the substrate proximate the first radial edge and a second adjacent inner edge;

FIG. 4 is a perspective view of a pad of disposable funnels where the repositionable adhesive strips shown in FIG. 2 bind the individual disposable funnels to one another to form the pad;

FIG. 5 is a perspective view of a second embodiment of the funnel of the invention in use atop a bottle;

### DETAILED DESCRIPTION OF THE PREFERRED EMBODIMENT

At the outset, it should be appreciated that like drawing numbers are different drawing views identify identical structural elements of the invention. Four different embodiments of the present invention are described herein, although it should be appreciated that the invention as claimed is not intended to be limited in scope to the exact four embodiments described. For example, the funnels of the present invention can be made with a variety of different adhesives and adhesives schemes. The repositionable adhesive version of the present invention also comprises a pad of funnels, where each individual unformed funnel is detachably secured to its adjacent neighbor(s). In the description that follows, the term “permanent adhesive” is intended to mean an adhesive that does not require water or moisture for activation. The term “repositionable” adhesive is intended to refer to an adhesive that may be used repeatedly to secure the same two surfaces to one another. In other words, a first surface may be secured to a second surface with adhesive, and then the first surface may be detachably removed from the surface and then “repositioned” on the second surface by way of the adhesive.

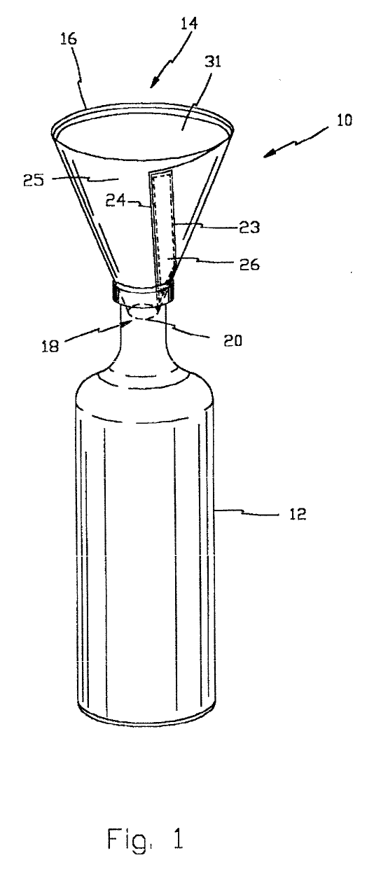

Adverting now to the drawings, FIG. 1 is a perspective view illustrating one use of the invention. The invention is seen to broadly comprise a funnel 10. The funnel is shown mounted within the neck of a bottle 12. The funnel is seen to be generally conical in shape, comprising a round inlet 14 of greater diameter than round outlet 18. Edge 16 defines the boundary of inlet 14, and edge 20 defines the boundary of outlet 18. Repositionable adhesive 23 disposed on bottom surface 31 of the funnel proximate first radial edge 24 secures the bottom surface to top surface 25, to form the funnel.

As is well known, in use, material is dispensed into large diameter opening 14 and falls through smaller diameter opening 18 into bottle 12. Since adhesive 23 is repositionable, the diameter of each of the openings, and the general shape of the funnel, can be adjusted by repositioning the adhesive strip to alternative positions on top surface 25 of the funnel.

An unformed first embodiment of the funnel of the invention is shown in bottom plan view in FIG. 2. The unformed funnel comprises planar annular-shaped substrate 30 which, in a preferred embodiment, is made of paper. The funnel may be made of any suitable material, however, such as plastic, aluminum or other metal, etc., capable of being formed into a conically shaped funnel. Substrate 30 is bounded by upper edge 16, lower edge 20, first radial edge 24 and second radial edge 22. Repositionable adhesive 23 is disposed on bottom surface 31 proximate first radial edge 24 and a release coating strip 26 is disposed on top surface 25 proximate first radial edge 24 and has an area at least as large and the same shape as the corresponding repositionable adhesive strip 23 on surface 31. In the embodiment shown, the adhesive is disposed parallel to the first radial edge, although this orientation is not critical. Also, repositionable adhesive 23 can be aligned proximate second radial edge 22 on bottom surface 31.

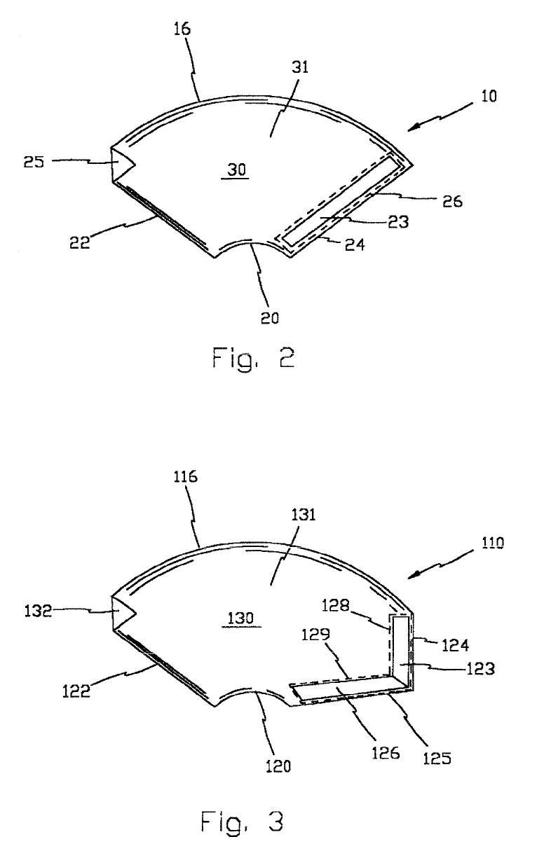

FIG. 3 illustrates a bottom plan view of a second embodiment 110 of the disposable funnel of the invention. In this embodiment, substrate 130 is bounded by upper edge 116, lower edge 120, first radial edge 124, second radial edge 122, and lower straight edge 125. This embodiment comprises two repositionable adhesive strips 123 and 126 disposed on bottom surface 131 proximate edges 124 and 125, respectively and two release coating strips 128 and 129 disposed on top surface 132 proximate edges 124 and 125 and have areas at least as large and the same shape as the corresponding repositionable adhesive strips 123 and 126 on surface 132.. This embodiment is suitable for forming funnels having larger inlet diameters and/or greater ratios of inlet diameter/outlet diameter, and the additional adhesive strip functions to form a more stable funnel as well.

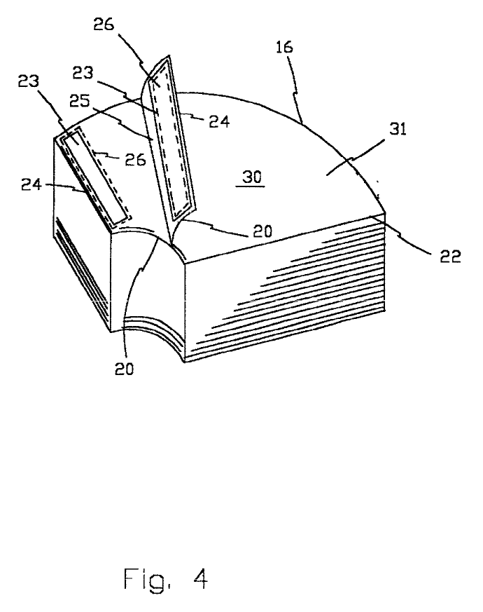

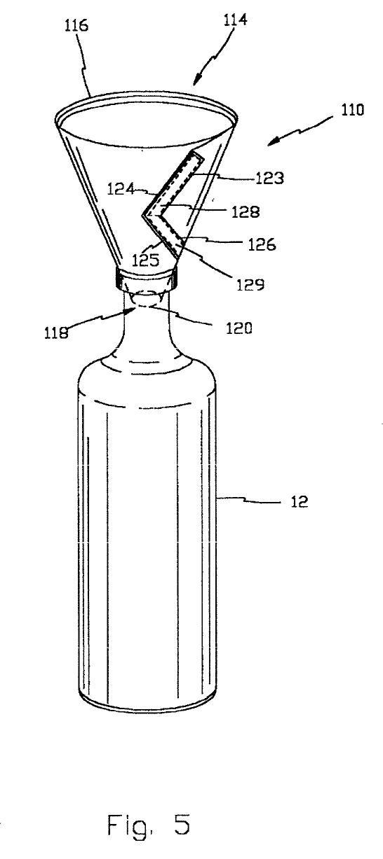

A pad of the disposable funnels of the invention is shown in perspective view in FIG. 4. In this view, a plurality of the funnels of the first embodiment is arranged in register with one another. Repositionable adhesive 23 affixed to the bottom surface of each individual unformed funnel proximate first radial edge 24 detachably secures the funnel to the corresponding release coating strip 26 on the top surface of its adjacent neighbor. The pad offers a convenient way of storing and dispensing individual funnels. It should be appreciated that it is the repositionable adhesive that makes the pad possible in the form shown in FIG. 4, although a pad of funnels which use permanent adhesive could be assembled in a like manner.

As shown in FIG. 4, all of the individual funnels in the pad are the same size. However, it should be apparent that it is possible to assemble a pad of different size individual funnels. Also, while not shown, the bottom funnel in the pad is likely detachably secured by repositionable adhesive to a backer panel.

FIG. 5 is a view similar to that of FIG. 1, except showing second funnel embodiment 110 (shown in FIG. 3) mounted atop bottle 12.

It should also be readily apparent that while the embodiments illustrated show a continuous strip of adhesive 23, a bridge portion might exist, such that the continuity of the adhesive strip is broken, while still fulfilling the object of the invention.

While the present invention has been described with respect to what is presently considered to be the preferred embodiments, it is understood that the invention is not limited to the disclosed embodiments. The present invention is intended to cover various modifications and equivalent arrangements included within the spirit and scope of the appended claims.

What is claimed is:

1. A disposable funnel comprising a planar annular-segment substrate having a top surface and a bottom surface, said substrate bounded by a first radial edge and a second radial edge, said substrate having a strip of repositionable adhesive disposed on said bottom surface proximate said first radial edge, said substrate operatively arranged to be formed into a conical-shaped funnel, where said repositionable adhesive disposed on said bottom surface proximate said first radial edge is detachably secured to said top surface proximate said second radial edge.

2. A disposable funnel as recited in claim 1 wherein said substrate is a sheet of paper.

3. A disposable funnel as recited in claim 1 wherein said substrate is a sheet of plastic.

4, A disposable funnel comprising a planar annular-segment substrate having a top surface and a bottom surface, said substrate bounded by a first radial edge and a second radial edge, said substrate having a strip of adhesive disposed on said bottom surface proximate said first radial edge, said substrate operatively arranged to be formed into a conical-shaped funnel, where said adhesive disposed on said bottom surface proximate said first radial edge is detachably secured to said top surface proximate said second radial edge.

5. A disposable funnel as recited in claim 4 further comprising a silicone-coated release liner operatively arranged to cover said strip of adhesive.

6. A disposable funnel as recited in claim 4 wherein said adhesive is permanent adhesive.

7. A pad of disposable funnels comprising at least two of said disposable funnels, where each of said disposable funnels comprises a planar annular-segment substrate having a top surface and a bottom surface, said substrate bounded by a first radial edge and a second radial edge, said substrate having a strip of repositionable adhesive disposed on said bottom surface proximate said first radial edge, where said repositionable adhesive functions to detachably secure said individual disposable funnels to one another.

8. A pad as recited in claim 7, wherein said first and second radial edges of each of said individual disposable funnels coincide.

9. A pad as recited in claim 7, wherein said strip of repositionable adhesive of one of said individual disposable funnels is detachably secured to a backer substrate.
